(19) United States
(12) Patent Application Publication
(10) Pub. No.: US 2018/0361321 A1
(43) Pub. Date: Dec. 20, 2018

(54) MONOLITHIC FILTER

(71) Applicant: SAINT-GOBAIN CENTRE DE RECHERCHES ET D'ETUDES EUROPEEN, Courbevoie (FR)

(72) Inventor: Paul LEPLAY, Robion (FR)

(21) Appl. No.: 16/061,940

(22) PCT Filed: Dec. 14, 2016
(86) PCT No.: PCT/FR2016/053422

§ 371 Date: Jun. 13, 2018

(30) Foreign Application Priority Data
Dec. 18, 2015 (FR) 1562810

(51) Int. Cl. B01D 63/06; B01D 71/02; B01D 69/02

(52) U.S. Cl. CPC B01D 63/066; B01D 71/02; B01D 2325/20; B01D 69/02; B01D 63/061

(57) ABSTRACT

A monolithic membrane filter for the filtration of liquids includes a support formed from a porous inorganic material of permeability Kₛ, the support exhibiting a tubular shape having a main axis, an upstream base, a downstream base, a peripheral surface and an internal portion; channels parallel to the main axis of the support, formed in the internal portion of the support, the channels separated from one another by internal walls formed from the porous inorganic material; a formed in the internal portion of the support and opening onto the peripheral surface so that the filter has an external surface formed by the peripheral surface of the support and the surface of said at least one slot; and a membrane of permeability Kₘ and of mean thickness tₘ covering the internal surface of the channels.

The invention relates to the field of filtering structures made of an inorganic material which are intended for the filtration of liquids, in particular structures coated with a membrane in order to separate particles or molecules from a liquid, more particularly water, in particular produced water derived from oil or shale gas extraction.

Filters which use ceramic or nonceramic membranes to carry out the filtration of various fluids, in particular polluted water, have been known for a long time. These filters can operate according to the principle of frontal filtration, this technique involving the passage of the fluid to be treated through a filtering media perpendicularly to its surface. This technique is limited by the accumulation of particles and the formation of a cake at the surface of the filtering media, and therefore gives rise to a rapid drop in performance and also a drop in the level of filtration.

According to another technique to which the present invention also relates, use is made of tangential filtration which, in contrast, makes it possible to limit the accumulation of particles by virtue of the longitudinal circulation of the fluid at the surface of the membrane. The particles remain in the circulating stream, while the liquid can pass through the membrane under the effect of a pressure difference. This technique provides stability of the performance and of the level of filtration. It is more particularly recommended for the filtration of fluids highly laden with particles and/or with molecules.

The strong points of tangential filtration are thus its ease of use, its reliability, by virtue of the use of membranes having a porosity suitable for carrying out said filtration, and its continuous operation.

Tangential filtration requires little or no adjuvant and provides two separate fluids which may both be of economic value: the concentrate (also known as retentate) and the filtrate (also known as permeate); it is a clean process which is environmentally friendly.

These filters are made from monolithic structures or tubular supports made of a porous inorganic material formed of walls that delimit longitudinal channels parallel to the axis of said supports, through which the liquid to be filtered passes. The liquid purified of its particles or molecules is then discharged via the peripheral surface of the porous support.

The internal surface of the channels is customarily covered with a separating membrane. This membrane comprises, or even is essentially formed by, a porous inorganic material, the nature and the morphology of which are suitable for halting the molecules or the particles, insofar as their size is close to or greater than the median diameter of the pores of said membrane.

Various geometries have been proposed in order to improve the usage properties of such membrane filters. U.S. Pat. No. 4,069,157 discloses for example a multichannel structure of which the surface, the density of the channels and the porosity of the support are optimized in order to increase the flow while minimizing the bulkiness of the filter. In order to reduce the hydraulic resistance of the filter, it has been proposed to provide discharge channels or slots according to various geometries (U.S. Pat. No. 4,781,831, U.S. Pat. No. 5,855,781, U.S. Pat. No. 6,077,436, EP 1457243, EP 1607129). The slots may be made by machining the filter after curing or during extrusion as is more particularly proposed by US 2001/0020756.

However, none of the structures described in the prior art makes it possible to ensure a maximum efficiency of the filters. Consequently, there is still a need for a filtering structure having a maximum filtration efficiency, i.e. having a maximized filtrate flow at equal bulkiness and fixed characteristics as regards the wall of the support and its membrane.

The Applicant observed that it was still possible to maximize the filtrate flow in filtering monolithic structures comprising discharge slots by taking into account the physical characteristics of the support and of the membrane in order to determine the geometry of the filter. Unlike the previous solutions that propose various configurations of discharge channels or slots by taking into account only the geometric characteristics of the filters, the present invention proposes to select a slot configuration so as to comply with a mean path distance of the liquid to be filtered through the support before being discharged in the form of filtrate, this mean path distance being determined not only on the basis of the geometric characteristics of the support but also on the basis of the physical characteristics of the support and of the membrane, in particular on the basis of their permeability and of the thickness of the membrane.

Thus, the present invention relates to a monolithic membrane filter for the filtration of liquids, in particular tangential filtration, comprising:
a support formed from a porous inorganic material of permeability Kₛ, said support exhibiting a tubular general shape having a main axis, an upstream base, a downstream base, a peripheral surface and an internal portion;
a plurality of channels parallel to the main axis of the support, formed in the internal portion of the support, the channels being separated from one another by internal walls formed from the porous inorganic material;
at least one slot formed in the internal portion of the support and opening onto the peripheral surface of the support so that the filter has an external surface formed by the peripheral surface of the support and the surface of said at least one slot; and
a membrane of permeability Kₘ and of mean thickness tₘ covering the internal surface of the channels;
characterized in that the mean path distance D, defined by the arithmetic mean of the minimum distances between the center of each channel and the extemal surface of the filter, satisfies the equation (1):

D=α*exp(B)*(Kₛtₘ/Kₘ)^{A} (1)

wherein
α is a coefficient within a range of from 0.0008 to 0.0012;
A=−21.5*Ø_{c}+15.4*pᵢ+0.16*Ø_{f}+0.31; and
B=561*pᵢ+101 Ø_{c}+1.16;
where Ø_{c} is the mean hydraulic diameter of the channels, Ø_{f} is the hydraulic diameter of the filter and pᵢ is the mean thickness of the internal walls.

In the equation (1), the quantities are conventionally expressed in SI units, namely in meters (m) for the quantities D, tₘ, Ø_{c}, pᵢ and Ø_{f}, and in square meters (m²) for the quantities Kₛ and Kₘ.

The permeability of the support Kₛ and of the membrane Kₘ are defined on the basis of the Kozeny-Carman equation by the following formula:

K=(PO³*D₅₀²)/[180*(1−PO)²] in which PO is the open porosity and D₅₀ is the median pore diameter.

The open porosity and the median pore diameter of the support according to the present invention are determined in a known manner by mercury porosimetry. The porosity, corresponding to the pore volume, is measured by mercury intrusion at 2000 bar using a mercury porosimeter such as the Micromeritics Autopore IV 9500 series porosimeter, on a 1 cm³ sample taken from a block of the support, the sampling region excluding the skin typically extending up to 500 microns from the surface of the block. The applicable standard is the ISO 15901-1.2005 part 1 standard. The increase in pressure up to high pressure results in “pushing” the mercury into pores of increasingly small size. The intrusion of the mercury is conventionally carried out in two steps. In a first step, mercury intrusion is carried out at low pressure up to 44 psia (around 3 bar), using air pressure to introduce the mercury into the largest pores (>4 μm). In a second step, high-pressure intrusion is carried out with oil up to the maximum pressure of 30 000 psia (around 2000 bar). In accordance with Washburn's law mentioned in the ISO 15901-1.2005 part 1 standard, a mercury porosimeter thus makes it possible to establish a size distribution of the pores by volume. The median pore diameter of the support corresponds to the threshold of 50% of the population by volume.

The porosity of the membrane, corresponding to the total volume of the pores in the membrane, and the median pore diameter of the membrane are advantageously determined according to the invention with the aid of a scanning electron microscope. Within the context of the present invention, it is considered that the porosity obtained for the membrane by this method may be likened to the open porosity. Typically, sections of a wall of the support in transverse cross section are produced, so as to visualize the entire thickness of the coating over a cumulative length of at least 1.5 cm. The images are acquired from a sample of at least 50 grains, preferably of at least 100 grains. The area and the equivalent diameter of each of the pores are obtained from images by conventional image analysis techniques, optionally after a binarization of the image that aims to increase the contrast thereof. A distribution of equivalent diameters is thus deduced, from which the median pore diameter is extracted. The porosity of the membrane is obtained by integration of the curve of distribution of equivalent pore diameters. Likewise, a median size of the particles constituting the membrane layer can be determined by this method. An example of determination of the median pore diameter or of the median size of the particles constituting the membrane layer, by way of illustration, comprises the following sequence of steps, which is conventional in the field:

A series of SEM photographs is taken of the support with its membrane layer observed along a transverse cross section (that is to say, over the whole thickness of a wall). For greater clarity, the photographs are taken on a polished section of the material. The image is acquired over a cumulative length of the membrane layer at least equal to 1.5 cm, in order to obtain values representative of the whole of the sample.
The photographs are preferably subjected to binarization techniques, well known in image processing techniques, in order to increase the contrast of the outline of the particles or pores.
A measurement of the area is carried out for each particle or each pore constituting the membrane layer. An equivalent pore or grain diameter is determined, corresponding to the diameter of a perfect disk of the same area as that measured for said particle or for said pore (it being possible for this operation to be optionally carried out using dedicated software, in particular Visilog®, software sold by Noesis). A distribution of particle or grain size or of pore diameter is thus obtained according to a conventional distribution curve and a median size of the particles and/or a median diameter of pores constituting the membrane layer are thus determined, this median size or this median diameter respectively corresponding to the equivalent diameter dividing said distribution into a first population comprising only particles or pores with an equivalent diameter greater than or equal to this median size and a second population comprising only particles with an equivalent diameter less than this median size or this median diameter.

In the present application, the hydraulic diameter of the filter or of a channel is conventionally defined by the formula 4*S/P, S being the area of the overall section (that is to say without taking account locally of the loss of section linked to the area of the slot or of the walls) of the filter perpendicular to the main axis, or the area of the section of the channel perpendicular to the main axis, and P being the perimeter of this section.

The shape of the support defines the general shape of the filter. It has an elongated tubular shape along a main axis and comprises an upstream base, a downstream base, a peripheral surface and an internal portion. The upstream and downstream bases, having identical shapes and dimensions, may be of varied shape, for example square, hexagonal or circular. They are preferably circular. The downstream base is intended to be positioned on the side of the flow of incoming liquid (liquid to be filtered) and the upstream base on the side opposite the flow of incoming liquid. The support typically has a hydraulic diameter Ø_{f} of from 50 to 300 mm, preferably 80 to 230 mm, and a length of from 200 to 1500 mm.

The support is formed from a porous inorganic material, in particular a non-oxide ceramic material, such as SiC, in particular recrystallized SiC, Si₃N₄, Si₂ON₂, SiAlON, BN or a combination thereof. Its porosity is typically from 20% to 70%, preferably from 40% to 50%, and the median pore diameter is from 5 nm to 50 μm, preferably from 100 nm to 40 μm, more preferentially from 5 to 30 μm. The permeability of the support Kₛ is preferably between 1.0×10⁻¹⁵ and 1.0×10⁻¹², preferably between 6.9×10⁻¹⁵ and 3.4×10⁻¹¹ m².

A plurality of channels parallel to the main axis of the support is formed in the internal portion of the support. These channels, also referred to as filtering channels, are preferably not plugged at their ends and open onto each of the bases of the support. The shape of the channels is not limited and the latter may have a polygonal, in particular pentagonal or hexagonal or square, or circular section but preferably have a circular or square section. The mean hydraulic diameter of the channels Ø_{c} is generally from 1 to 5 mm, preferably 2 to 4 mm. The filter may comprise several categories of channels. One category of channels is defined by a set of channels having a same shape and an identical hydraulic diameter to within ±5%. For example, the filter may comprise a first category of channels consisting of channels located close to the peripheral surface of the filter and a second category consisting of channels located at the center of the filter, the channels of the first category having a hydraulic diameter greater than those of the second category. Preferably, the filter comprises only a single category of channels.

The channels are separated from one another by internal walls formed by the porous inorganic material of the support. The mean thickness of the internal walls pᵢ is typically from 0.3 to 2 mm, preferably from 0.4 to 1.2 mm.

The filter also comprises a membrane covering the internal surface of the channels. It is formed from a porous inorganic material, in particular a non-oxide ceramic material, such as SiC, in particular recrystallized SiC, Si₃N₄, Si₂ON₂, SiAlON, BN or a combination thereof. Its porosity is typically from 10% to 70% and the median pore diameter is from 10 nm to 5 μm. The permeability of the membrane Kₘ is preferably from 10⁻¹⁹ to 10⁻¹⁴ m². It typically has a mean thickness tₘ of from 0.1 to 300 μm, preferably from 1 to 200 μm, more preferentially from 10 to 80 μm.

The ratio Kₛ*tₘ/Kₘ is in general equal to 0.01 to 100, preferably 0.1 to 10, more preferably 0.1 to 5.

The filter according to the invention comprises at least one slot formed in the internal portion of the filter and opening onto the peripheral surface. Thus, the external surface of the filter is formed, on the one hand, by the surface of said at least one slot and, on the other hand, by the peripheral surface of the support. Within the meaning of the present invention a “slot” is understood to mean the space formed, on the one hand, by a cavity, created by machining the support or made during the shaping of the support in place of a portion of the channels in the internal portion of the support, and opening onto the peripheral surface of the support; and, on the other hand, by the channels directly connected to this cavity, that is to say which are not separated from the cavity by an internal wall of the support. The channels directly connected to the cavities of the slots, also referred to as discharge channels as opposed to the filtering channels described above, help to improve the discharging of the filtrate by draining this filtrate toward the cavities that open outside of the filter. In order to preserve the filtration capacity of the filter, the discharge channels should obviously be plugged at each of the bases of the support. Thus, the slots make it possible to facilitate the extraction and discharging of the filtrate at the periphery of the filter by reducing the hydraulic resistance of the filter.

The shape of the cavities, which determines the shape of the slots, is not in theory limited. However, for manufacturing and/or mechanical strength constraints, the cavities are preferably rectilinear. A rectilinear cavity is defined as a cavity in a plane parallel to the main axis, preferably essentially parallelepipedal, the length of which extends parallel to the main axis, the depth and the width extending perpendicular to the main axis. The width of a cavity preferably corresponds to the width of a set number of channels, preferably to the width of one channel, for example from 0.5 and 5 mm, or even from 1 to 3 mm. The length of a cavity is obviously at most equal to the length of the filter. In order to retain a good mechanical strength, the length of a cavity is however preferably between 1% to 20% of the length of the filter, for example from 1 to 20 cm, or even from 3 to 15 cm. The depth of the cavity is obviously at most equal to the width of the filter in the plane, parallel to the main axis, of the cavity considered A cavity may in particular be a through cavity, that is to say opening at its two ends in the depth direction onto the peripheral surface of the support. This configuration has the advantage of maximizing the discharge surface provided by the cavity. A cavity may also be a blind, or non-through cavity, that is to say opening only at one of its ends in the depth direction onto the peripheral surface of the support. In this case, the depth of the cavity is preferably from 25% to 40% of the width of the filter in the plane, parallel to the main axis, of the cavity considered. In one particular embodiment, at least one cavity is blind. In one particular embodiment, all the cavities are blind. This configuration makes it possible to maximize the mechanical strength of the filter while retaining a maximum of filtering channels and a sufficient discharge surface.

The number of slots and their configurations are determined so as to obtain a mean path distance D that satisfies the equation (1) defined above, wherein the coefficient α is from 0.0008 to 0.0012, preferably from 0.0009 to 0.0011, ideally around 0.001. More specifically, the minimum distance dᵢ between the center of each channel and the external surface of the filter is preferably such that the ratio σ/D is less than 0.65, or less than 0.6 or even less than 0.55, wherein D is the mean path distance as defined above and σ is the standard deviation of the distances dᵢ relative to the mean path distance D. For this, the filter generally comprises a plurality of slots. Furthermore, the slots are generally distributed relatively uniformly in the internal portion of the filter, for example so that the distances between each of the slots and the direct neighbors thereof are as constant as possible. The slots are preferably each positioned in a plane parallel to the main axis. They may be positioned radially, that is to say all being positioned in a plane parallel to the main axis and passing through this axis. They may also be positioned in planes that are parallel to one another and to the main axis and that are preferably equidistant from one another. It is understood that, for a given filter, a plurality of slot configurations may make it possible to obtain a same mean path distance D according to the invention.

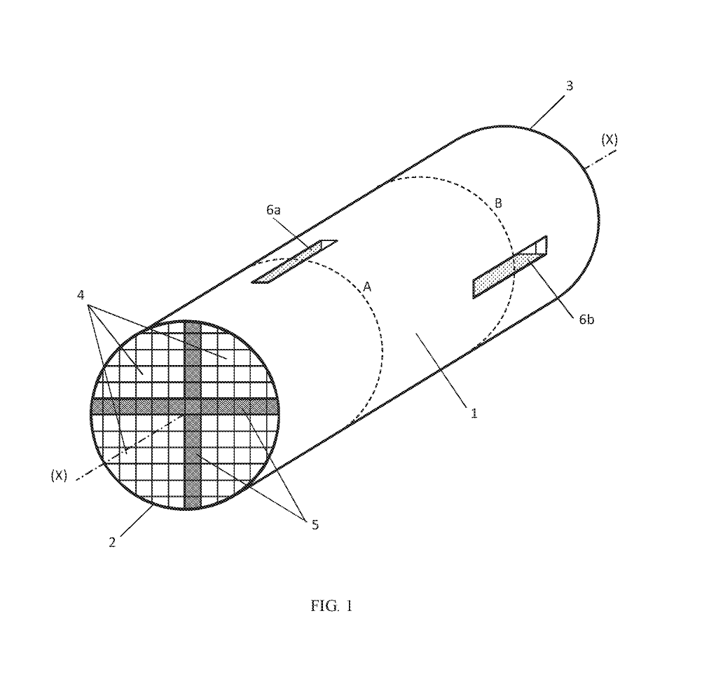

FIG. 1 illustrates a filter comprising a support 1 of cylindrical shape having a main axis (X), an upstream base 2 and a downstream base 3. A plurality of channels parallel to the main axis (X) are formed in the internal portion of the support and separated from one another by internal walls, comprising filtering channels 4 and discharge channels 5. The filtering channels 4, opening onto each of the upstream 2 and downstream 3 bases, are covered on their internal surface by a membrane (not represented). The discharge channels 5 are plugged level with the upstream base 2 and with the downstream base 3. The filter also comprises two through cavities 6a and 6b that are perpendicular to one another and are positioned at different levels along the filter. The cavities 6a and 6b, each with the discharge channels 5 that are connected thereto, thus form two slots that are perpendicular to one another over the whole of the length of the filter.

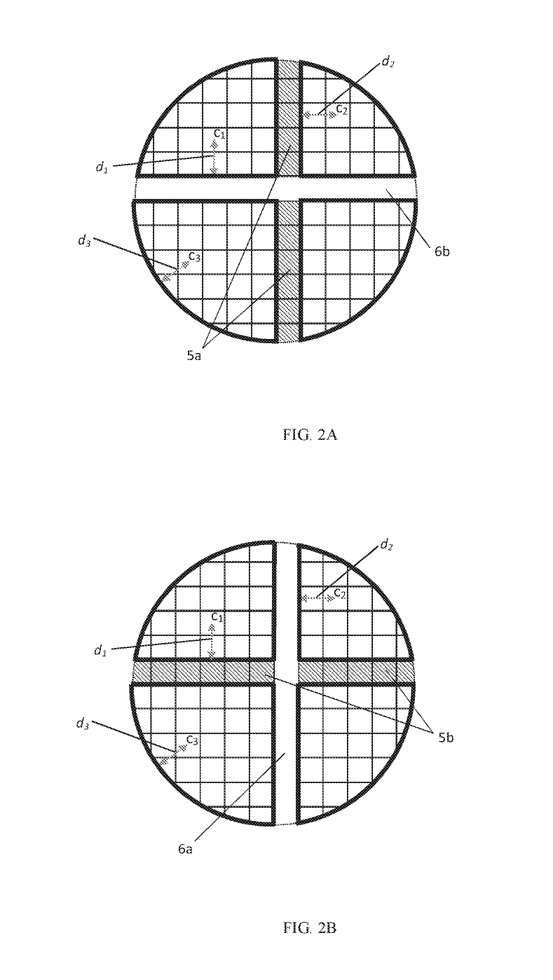

The mean path distance D is the arithmetic mean of all of the minimum distances dᵢ between each filtering channel cᵢ and the extemal surface of the filter. The distance dᵢ is measured for each filtering channel cᵢ by considering a sectional plane perpendicular to the main axis onto which all of the slots are transferred, by projection. Since the slots extend over the whole of the length of the filter (either in the form of a cavity, or in the form of discharge channels), the minimum distance dᵢ for a given filtering channel will be the same irrespective of the sectional plane considered. For example, by considering the filter represented in FIG. 1, the figures FIGS. 2A and 2B respectively represent cross sections of the filter at the sectional planes A and B perpendicular to the main axis (X) represented as dotted lines in FIG. 1. In FIGS. 2A and 2B, the hollowed out portions represent the cavities 6a and 6b and the hatched portions represent the discharge channels 5a, connected to the cavity 6a, and 5b, connected to the cavity 6b. The external surface of the filter, as defined in the present invention, is represented by a thick line in FIGS. 2A and 2B and comprises, on the one hand, the peripheral surface of the support and, on the other hand, the surface of the slots, that is to say the internal surfaces of the cavities and of the discharge channels. Thus, it is possible for example to determine the distances d₁, d₂ and d₃ (represented by the double-headed arrows in FIGS. 2A and 2B) corresponding respectively to the filtering channels c₁, c₂ and c₃ either from the sectional plane of FIG. 2A or of FIG. 2B.

The filter according to the invention may be obtained by any technique well known to person skilled in the art. A conventional manufacturing process generally comprises the following main steps:
manufacture of the support;
deposition of the membrane; and
production of the slots.

The support is preferably obtained by extrusion of a paste through a die, followed by a drying and a firing in order to sinter the material of the support and to obtain the porosity and mechanical strength characteristics necessary for the application. When it is a support made of recrystallized SiC, it may in particular be obtained according to the following manufacturing steps:
mixing a mixture comprising silicon carbide particles with a purity of greater than 98% and having a particle size such that 75% by weight of the particles has a diameter of greater than 30 μm, the median diameter by weight of this particle size fraction, measured by laser particle size analysis, being less than 300 μm. The mixture also comprises an organic binder of the cellulose derivative type. Water is added and mixing is carried out until a homogeneous paste is obtained, the plasticity of which allows extrusion, the die being configured in order to obtain monoliths according to the invention;
microwave drying of the green monoliths for a time sufficient to bring the content of water that is not chemically bound to less than 1% by weight;
firing up to a temperature of at least 1900° C. and below 2400° C. typically maintained for at least 1 hour and preferably for at least 3 hours. The material obtained has an open porosity of from 20% to 70%, preferably from 40% to 50% by volume and a median pore diameter of the order of from 5 nm to 50 μm, preferably from 100 nm to 40 μm, more preferentially from 5 to 30 μm.

The filtering support is then coated with a membrane. The membrane may be deposited according to various techniques known to a person skilled in the art: deposition using suspensions or slips, chemical vapor deposition (CVD) or deposition by thermal spraying, for example plasma spraying. Preferably, the membrane layers are deposited by coating using slips or suspensions. The membrane may be obtained by the deposition of several successive layers. The membrane generally comprises a first layer, referred to as a primer, deposited in direct contact with the substrate. The primer acts as a tie layer. The slip used for the deposition of the primer comprises 50% by weight of SiC grains having a median diameter of from 10 to 30 μm and 50% by weight of deionized water. The membrane also comprises a separating layer deposited on the primer layer. It is in this separating layer that the porosity is controlled in order to give the filter its selectivity. The slip used for the deposition of the separating layer comprises 50% by weight of SiC grains having a median diameter of from 0.1 to 2 μm and 50% by weight of deionized water. Certain additives such as thickeners, binders and/or dispersants may be added to the slips in order to control their rheology in particular. The viscosity of the slips is typically from 0.05 to 0.5 Pa·s, preferably from 0.01 to 0.3 Pa·s, measured at 22° C. under a shear gradient of 1 s⁻¹ according to the DIN-53019-1:2008 standard. The slips may typically comprise from 0.1% to 1% of the weight of water of thickeners preferably selected from cellulose derivatives. They may typically comprise from 0.1% to 5% of the weight of SiC powder of binders preferably selected from polyvinyl alcohol (PVA) or and acrylic derivatives. The slips may also comprise from 0.01% to 1% of the weight of SiC powder of dispersants preferably selected from ammonium polymethacrylates. One or more layers of slip may be deposited in order to form the membrane. The deposition of a layer of slip typically makes it possible to obtain a membrane with a thickness of from 0.1 to 80 μm, but thicker membranes, typically of from 100 to 300 μm, may be obtained by the deposition of several successive layers of slip.

The support thus coated is then dried at ambient temperature typically for at least 30 minutes then at 60° C. for at least 24 hours. The supports thus dried are then sintered at a firing temperature typically between 1000° C. and 2200° C. under a non-oxidizing atmosphere, preferably under argon, so as to obtain a membrane porosity, measured by image analysis, of from 10% to 70% by volume and an equivalent median pore diameter, measured by image analysis, of from 10 nm to 5 μm.

The slots are then produced by machining cavities in the support and plugging discharge channels at the upstream base and downstream base.

The slots are created by machining the cavities by sawing the support, generally before firing, on the dried support. Before or after machining, the discharge channels connected to the cavity are plugged according to well-known techniques, for example described in application WO 2004/065088, at each of the downstream and upstream bases of the support, generally before the firing thereof. The support is preferably sintered once the machining and plugging operations have been carried out and before the deposition of the membrane.

The filter according to the invention may be used for various applications for purifying liquids and/or separating particles or molecules from a liquid. The filter according to the invention makes it possible to maximize the filtrate flow independently of the viscosity of the liquid to be filtered. It may be used to filter liquids having for example a dynamic viscosity of from 0.1 to 20 mPa·s, or even 50 mPa·s. The dynamic viscosity of the fluid to be filtered may be measured at 20° C. under a shear gradient of 1 s⁻¹ according to the DIN-53019-1:2008 standard. The present invention relates in particular to the use of a filter as described above for the purification of produced water derived from oil or shale gas extraction. It also finds an application in various industrial processes for purifying and/or separating liquids in the chemistry, pharmaceutical, food, agri-food or bioreactor fields.

The present invention is illustrated with the aid of the following nonlimiting examples.

### EXAMPLES

Examples of tangential filters according to the invention (examples 1A, 1B and 2 to 7) and comparative examples (C1 to C7) were prepared according to the processes described below.

### Examples 1A and 1B

A support was produced according to techniques well known to a person skilled in the art by forming a silicon carbide honeycomb. In order to do this, the following are mixed in a kneader:
3000 g of a mixture of the two powders of silicon carbide particles with a purity of greater than 98% comprising 75% by weight of a first powder of grains having a median diameter of around 60 μm and 25% by weight of a second powder of grains having a median diameter of around 2 μm; and
300 g of an organic binder of the cellulose derivative type. Water, around 25% by weight relative to the weight of SiC and of organic binder, is added and kneading is carried out until a homogeneous paste is obtained, the plasticity of which allows extrusion.

The support is extruded from this paste using a die to obtain a cylindrical green monolith block with a diameter of 150 mm and a length of 300 mm, the internal portion of which has a plurality of channels of square section. The shape of the die is suitable for obtaining channels having a hydraulic diameter of 4 mm and internal walls with a mean thickness of 1.2 mm.

The green monolith obtained is subsequently dried by microwave radiation for a time sufficient to bring the content of water that is not chemically bound to less than 1% by weight, then fired up to a temperature of at least 2050° C., which is maintained for 5 hours. The support obtained has an open porosity of 50% and a median pore diameter of around 10 μm.

A membrane is then deposited on the internal surface of the channels. The deposition of the membrane is carried out by slip coating. For this, a first primer layer is deposited from a slip comprising 50% by weight of SiC grains having a median diameter of around 20 μm and 50% of deionized water. A separating layer is then deposited on the primer layer from a slip comprising 50% by weight of SiC grains having a median diameter of around 1 μm and 50% of deionized water. The viscosity of the slips, measured at 22° C. under a shear gradient of 1 s⁻¹ according to the DIN-53019-1:2008 standard, is adjusted to 0.1 Pa·s with the aid of additives well known to a person skilled in the art.

The primer and the membrane are deposited according to the same process. The slip is introduced into a tank stirred at 20 rpm After a phase of deaerating under slight vacuum (typically 25 mbar), while maintaining the stirring, the tank is placed under a slight positive pressure of around +1 bar in order to be able to coat the inside of the support from the bottom up to the top. This operation only takes a few seconds for a 300 mm long support. The slip coats the internal wall of the channels of the support and the excess is then discharged by gravity immediately after deposition.

Next, the coated support is dried at ambient temperature for 30 minutes then at 60° C. for 30 h. The coated support thus dried is then sintered at a temperature of 1350° C. under an argon atmosphere for 4 hours in order to obtain a porosity of the membrane of 40% with a median pore diameter of 200 nm.

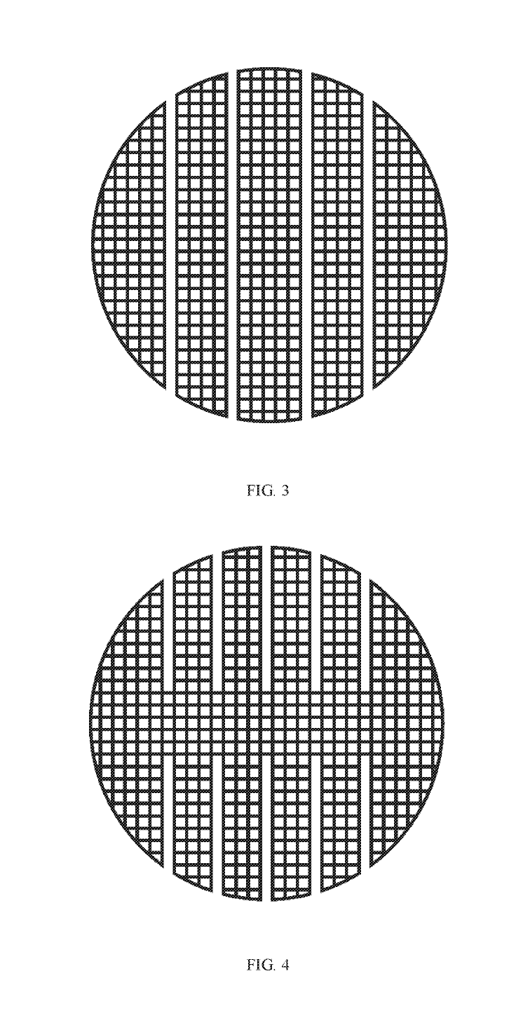

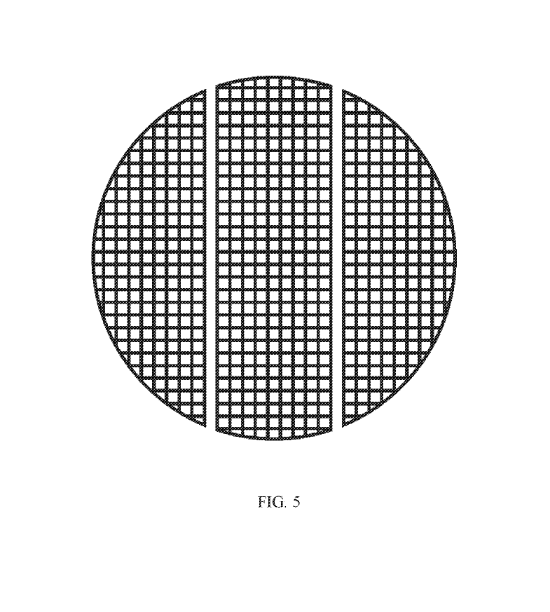

Cavities were machined in the dried support and the discharge channels connected to the cavities were plugged according to well-known techniques as described in application WO 2004/065088 in order to create slots, before sintering the support. The slots were positioned so as to obtain a mean path distance D that satisfies the equation (1) according to the invention, that is to say a distance D of between 5.7 and 8.5 mm in the case of examples 1A and 1B. In the case of example 1A, 4 through cavities with a length of 50 mm and a thickness equal to a channel (4 mm), which are parallel to one another and to the main axis, are machined according to the diagram illustrated in FIG. 3. The slots are positioned in a regular manner with respect to one another, that is to say that the number of channels between two neighboring slots is constant to within plus or minus one channel. In the case of example 1B, 10 blind slots with a length of 50 mm, which are parallel to one another and to the main axis, are machined according to the diagram illustrated in FIG. 4. In FIGS. 3 and 4 representing sectional planes of the filters according to examples 1A and 1B respectively, the hollowed out portions represent the slots with no distinction between the cavities and the discharge channels.

### Comparative Example C1

A filter was prepared in a manner identical to that of example 1A except that only 2 slots were produced by machining 2 through cavities, parallel to one another and to the main axis, in the support according to the diagram illustrated in FIG. 5.

### Example 2

A filter was prepared in a manner identical to that of example 1A except that the shape of the die is suitable for obtaining channels having a hydraulic diameter of 2 mm and internal walls with a mean thickness of 1.2 mm; and 5 slots were produced by machining 5 through cavities, parallel to one another and to the main axis, in the support. The cavities have a length of 50 mm and a thickness equal to a channel (2 mm).

### Comparative Example C2

A filter was prepared in a manner identical to that of example 2 except that 3 slots were produced by machining 3 through cavities, parallel to one another and to the main axis, in the support. The cavities have a length of 50 mm and a thickness equal to a channel (2 mm).

### Example 3

A filter was prepared in a manner identical to that of example 1A except that the shape of the die is suitable for obtaining channels having a hydraulic diameter of 4 mm and internal walls with a mean thickness of 0.4 mm; and 7 slots were produced by machining 7 through cavities, parallel to one another and to the main axis, in the support. The cavities have a length of 50 mm and a thickness equal to a channel (4 mm).

### Comparative Example C3

A filter was prepared in a manner identical to that of example 3 except that 10 slots were produced by machining 10 through cavities, parallel to one another and to the main axis, in the support. The cavities have a length of 50 mm and a thickness equal to a channel (4 mm).

### Example 4

A filter was prepared in a manner identical to that of example 1A except that the dried coated support is sintered at a temperature of 1300° C. under an argon atmosphere for 4 hours in order to obtain a porosity of the membrane of 40% with a median pore diameter of 125 nm and 3 slots were produced by machining 3 through cavities, parallel to one another and to the main axis, in the support. The cavities have a length of 50 mm and a thickness equal to a channel (4 mm).

### Comparative Example C4

A filter was prepared in a manner identical to that of example 4 except that 7 slots were produced by machining 7 through cavities, parallel to one another and to the main axis, in the support. The cavities have a length of 50 mm and a thickness equal to a channel (4 mm).

### Example 5

A filter was prepared in a manner identical to that of example 1A except that the slip used for the deposition of the membrane comprises 12.3% by weight of SiC grains having a median diameter of around 0.5 μm, 64.4% of deionized water, 23.1% of PVA and 0.2% of deflocculant with reference to example 2 of EP 0 219 383. The coated and dried support is sintered at a temperature of 1050° C. under a nitrogen atmosphere for a hold of 4 hours in order to obtain a porosity of the membrane of 25% with a median pore diameter of 200 nm; and 2 slots were produced by machining 2 through cavities, parallel to one another and to the main axis, in the support. The cavities have a length of 50 mm and a thickness equal to a channel (4 mm).

### Comparative Example C5

A filter was prepared in a manner identical to that of example 5 except that 1 slot was produced by machining 1 through cavity, parallel to the main axis, in the support. The cavity has a length of 50 mm and a thickness equal to a channel (4 mm).

### Example 6

A filter was prepared in a manner identical to that of example 1A except that a longer contact time between the suspension and the support is selected in order to obtain a membrane having a mean thickness of 200 μm, this thickness being obtained by combining 4 layers of 50 μm with the deposition and drying process described in example 1A. The support thus coated and dried is sintered under the same conditions as example 1A; and 3 slots were produced by machining 3 through cavities, parallel to one another and to the main axis, in the support. The cavities have a length of 50 mm and a thickness equal to a channel (4 mm).

### Comparative Example C6

A filter was prepared in a manner identical to that of example 6 except that 6 slots were produced by machining 6 through cavities, parallel to one another and to the main axis, in the support. The cavities have a length of 50 mm and a thickness equal to a channel (4 mm).

### Example 7

A filter was prepared in a manner identical to that of example 1A except that the mixture used for manufacturing the support comprises:
3000 g of a mixture of the two powders of silicon carbide particles with a purity of greater than 98% comprising 70% by weight of a first powder of grains having a median diameter of around 11 μm and 30% by weight of a second powder of grains having a median diameter of around 0.5 μm; and
300 g of an organic binder of the cellulose derivative type;
   in order to obtain a support having a porosity of 35%; and 7 slots were produced by machining 7 through cavities, parallel to one another and to the main axis, in the support. The cavities have a length of 50 mm and a thickness equal to a channel (4 mm).

### Comparative Example C7

A filter was prepared in a manner identical to that of example 7 except that 4 slots were produced by machining 4 through cavities, parallel to one another and to the main axis, in the support. The cavities have a length of 50 mm and a thickness equal to a channel (4 mm).

For each of these filters, the ratio Φ/Φ₀ is determined in which Φ is the characteristic flow of the filter and Φ₀ is the characteristic flow of an identical filter without any slots. The characteristic flow of a filter was evaluated according to the following method: at a temperature of 25° C. a fluid consisting of demineralized water supplies the filters to be evaluated under a transmembrane pressure of 0.5 bar and a rate of circulation in the channels of 2 m/s. The permeate is recovered at the periphery of the filter. The measurement of the characteristic flow of the filter is expressed in L/h/m/bar after filtering for 20 h. The results obtained and also the dimensional characteristics of the filters thus obtained are summarized in table 1 below.

These examples demonstrate the importance of adapting the geometry of the filter on the basis of the physical parameters of the filter, such as the shape of the channels, the mean thickness of the internal walls, the mean thickness of the membrane, the median pore diameter of the membrane and the porosity of the membrane or of the support, so as to obtain a distance D according to the invention in order to maximize in order to maximize the filtrate flow. The filters according to the invention an increase in the characteristic flow that is at least 5% higher.

TABLE 1

| | Example | | | | | | | | |
|---|---|---|---|---|---|---|---|---|---|
| | 1A | 1B | C1 | 2 | C2 | 3 | C3 | 4 | C4 |
| Øf | 150 | 150 | 150 | 150 | 150 | 150 | 150 | 150 | 150 |
| Øc | 4 | 4 | 4 | 2 | 2 | 4 | 4 | 4 | 4 |
| pᵢ | 1.2 | 1.2 | 1.2 | 1.2 | 1.2 | 0.4 | 0.4 | 1.2 | 1.2 |
| D50ₘ | 200 | 200 | 200 | 200 | 200 | 200 | 200 | 125 | 125 |
| POₘ | 40 | 40 | 40 | 40 | 40 | 40 | 40 | 40 | 40 |
| tₘ | 50 | 50 | 50 | 50 | 50 | 50 | 50 | 50 | 50 |
| POₛ | 50 | 50 | 50 | 50 | 50 | 50 | 50 | 50 | 50 |
| D50ₛ | 10 | 10 | 10 | 10 | 10 | 10 | 10 | 10 | 10 |
| Kₛ * tₘ/Kₘ | 0.352 | 0.352 | 0.352 | 0.352 | 0.352 | 0.352 | 0.352 | 0.90 | 0.90 |
| Dᵢₙᵥ | 5.7-8.5 | | | 4.4-6.7 | | 3.6-5.5 | | 7.3-10.9 | |
| N_{f} | 4^{(a)} | 10^{(D)} | 2^{(a)} | 5^{(a)} | 3^{(a)} | 7^{(a)} | 10^{(a)} | 3^{(a)} | 7^{(a)} |
| D_{actual} | 6.7 | 6.3 | 8.8 | 6.0 | 9.1 | 3.8 | 3 | 8.5 | 4.1 |
| σ/D | 0.53 | 0.57 | 0.53 | 0.51 | 0.52 | 0.64 | 0.81 | 0.52 | 0.59 |
| Φ/Φ₀ | 2.77 | 2.74 | 2.19 | 2.75 | 2.14 | 4.33 | 3.99 | 1.91 | 1.79 |

| | Example | | | | | |
|---|---|---|---|---|---|---|
| | 5 | C5 | 6 | C6 | 7 | C7 |
| Øf | 150 | 150 | 150 | 150 | 150 | 150 |
| Øc | 4 | 4 | 4 | 4 | 4 | 4 |
| pᵢ | 1.2 | 1.2 | 1.2 | 1.2 | 1.2 | 1.2 |
| D50ₘ | 200 | 200 | 200 | 200 | 200 | 200 |
| POₘ | 25 | 25 | 40 | 40 | 40 | 40 |
| tₘ | 50 | 50 | 200 | 200 | 50 | 50 |
| POₛ | 50 | 50 | 50 | 50 | 35 | 35 |
| D50ₛ | 10 | 10 | 10 | 10 | 10 | 10 |
| Kₛ * tₘ/Kₘ | 2.25 | 2.25 | 1.406 | 1.406 | 0.0701 | 0.0701 |
| Dᵢₙᵥ | 9.3-13.9 | | 8.2-12.3 | | 3.7-5.5 | |
| N_{f} | 2^{(a)} | 1^{(a)} | 3^{(a)} | 6^{(a)} | 7^{(a)} | 4^{(a)} |
| D_{actual} | 11.4 | 16.1 | 8.4 | 4 .7 | 4.1 | 6.7 |
| σ/D | 0.53 | 0.59 | 0.56 | 0.57 | 0.58 | 0.58 |
| Φ/Φ₀ | 1.40 | 1.19 | 1.77 | 1.68 | 6.17 | 4.77 |

Ø_{f} hydraulic diameter of the filter (mm)
Ø_{c:} mean hydraulic diameter of the channels (mm)
P_{i:} mean thickness of the internal walls (mm)
D50_{m:} median pore diameter of the membrane (nm)
PO_{m:} open porosity of the membrane (%)
t_{m:} mean thickness of the membrane (μm)
PO_{s:} open porosity of the support (%)
N_{f} number of through ^{(a)} or blind ^{(b)} slots
D50_{s:} median pore diameter of the support (μm)
K_{s:} permeability of the support (m²)
K_{m:} permeability of the membrane (m²)
D_{inv:} range of D calculated according to the invention (mm)
D_{actual:} value of D measured according to the actual geometry of the filter (mm)
Φ_{:} characteristic flow of the filter (L/h/m/bar)
Φ_{0:} characteristic flow of an identical filter with 0 slots (L/h/m/bar)

1. A monolithic membrane filter for the filtration of liquids comprising:
a support formed from a porous inorganic material of permeability Kₛ, said support exhibiting a tubular shape having a main axis, an upstream base, a downstream base, a peripheral surface and an internal portion;
a plurality of channels parallel to the main axis of the support, formed in the internal portion of the support, said channels separated from one another by internal walls formed from the porous inorganic material;
at least one slot formed in the internal portion of the support and opening onto the peripheral surface so that the filter has an external surface formed by the peripheral surface of the support and the surface of said at least one slot; and
a membrane of permeability Kₘ and of mean thickness tₘ covering the internal surface of the channels;
wherein a mean path distance D satisfies the equation:
D=α*exp(B)*(Kₛtₘ/Kₘ)^{A}
wherein
α is a coefficient within a range of from 0.0008 to 0.0012;
A=−21.5*Ø_{c}+15.4*pᵢ+0.16*Ø_{f}+0.31; and
B=561*pᵢ+101Ø_{c}+1.16;
where Ø_{c} is the mean hydraulic diameter of the channels, Ø_{f} is the hydraulic diameter of the filter and pᵢ is the mean thickness of the internal walls; and
D, tₘ, Ø_{c}, pᵢ and Ø_{f} are expressed in m, and Kₛ and Kₘ are expressed in m²;
D being defined by the arithmetic mean of all of the minimum distances dᵢ between the center of each channel cᵢ and the external surface of the filter, the distances dᵢ being measured for each filtering channel cᵢ by considering a sectional plane perpendicular to the main axis onto which all of the slots are transferred.

2. The filter as claimed in claim 1, wherein a ratio σ/D is less than 0.65 wherein α is the standard deviation relative to the distance D of the minimum distances dᵢ between the center of each channel cᵢ and the external surface of the filter.

3. The filter as claimed in claim 1, wherein said at least one slot is/are each in a plane parallel to the main axis.

4. The filter as claimed in claim 1, wherein each of said at least one slot is formed by a cavity opening onto the peripheral surface of the support, with the channels directly connected to said cavity.

5. The filter as claimed in claim 4, wherein said cavity has a length of from 1% to 20% of a length of the filter.

6. The filter as claimed in claim 1, wherein said at least one slot is/are blind.

7. The filter as claimed in claim 1, wherein the support has square, hexagonal or circular bases.

8. The filter as claimed in claim 1, wherein the hydraulic diameter of the filter Ø_{f} is within a range extending from 50 to 300 mm.

9. The filter as claimed in claim 1, wherein the filter has a length of from 200 to 1500 mm.

10. The filter as claimed in claim 1, wherein the mean hydraulic diameter of the channels Ø_{c} is within a range extending from 1 to 5 mm.

11. The filter as claimed in claim 1, wherein all the channels have an identical hydraulic diameter.

12. The filter as claimed in claim 1, wherein the mean thickness of the internal walls pᵢ is within a range extending from 0.3 to 2 mm.

13. The filter as claimed in claim 1, wherein the support has an open porosity of from 20% to 70%.

14. The filter as claimed in claim 1, wherein the mean thickness of the membrane tₘ is within a range extending from 0.1 to 300 μm.

15. The filter as claimed in claim 1, wherein the membrane has an open porosity of from 10% to 70%.

16. A method comprising purifying and/or separating liquids in the chemistry, pharmaceutical, food, agri-food, bioreactor, or oil or shale gas extraction fields with a filter as claimed in claim 1.

17. The filter as claimed in claim 14, wherein the mean thickness of the membrane tₘ is within a range extending from 10 to 70 μm.
